(19) United States
(12) Patent Application Publication
(10) Pub. No.: US 2013/0103755 A1
(43) Pub. Date: Apr. 25, 2013

(54) VIRTUAL WORLD OPERATING SYSTEM AND OPERATING METHOD

(71) Applicants: Woo Chool Park, Incheon (KR); Hae Moon Seo, Yongin-si (KR); Kyong Ro Yoon, Seoul (KR)

(72) Inventors: Woo Chool Park, Incheon (KR); Hae Moon Seo, Yongin-si (KR); Kyong Ro Yoon, Seoul (KR)

(73) Assignee: KOREA ELECTRONICS TECHNOLOGY INSTITUTE, Seongnam-si, Gyeonggi-do (KR)

(21) Appl. No.: 13/806,629

(22) PCT Filed: Mar. 30, 2011
(86) PCT No.: PCT/KR2011/002197

§ 371 Date: Dec. 21, 2012

(30) Foreign Application Priority Data
Jun. 24, 2010 (KR) 10-2010-0059945

(51) Int. Cl. H04L 29/06; A63F 13/12

(52) U.S. Cl. CPC H04L 67/42
USPC 709/203

(57) ABSTRACT

The present invention relates to a virtual world operating system and operating method, and is adapted to support a variety of virtual worlds so as to allow linked operation or individual operation of the same by providing a base able to commonly define virtual objects and avatars present in a virtual world. Disclosed is a configuration that comprises: at least one service server which stores data for building at least one virtual world of the present invention and which builds a virtual world based on the data; and a network which supports a communication pathway for service server access, wherein the service server defines common feature types of virtual object types and avatar types positioned in the virtual world based on MPEG-V.

### TECHNICAL FIELD

The present invention relates generally to a virtual world and, more particularly, to a virtual world operating system and method for supporting the integrated or individual operation of a variety of virtual worlds by providing the basis for commonly defining virtual objects and avatars existing in a virtual world.

### BACKGROUND ART

Nowadays the Internet has become a part of everyday life in the modern society. Especially, mini homepage, blog, messenger, etc. that allow a personal expression have been popularized today, and also cyber characters have lately attracted attention as the graphical representation of the user or user's alter ego according to the advent of a virtual world such as what is called the second life.

This graphical icon used for the online representation of the user in a virtual world is often referred to as avatar. The term avatar which means user's alter ego or incarnation is a mixed word using the Sanskrit words “Ava” standing for the “descent” and “Terr” standing for the “earth”. While avatar referred to God incarnate descending to the earth in ancient India, it is now used as the term that means an animation character or graphic icon which replaces a user in a virtual world such as a cyber space. Furthermore, avatar is often interpreted as the meaning that covers an online identity. Now, avatar is widely used in various genres including online chatting services such as icon chatting or 3D graphic chatting, online games, cyber shopping malls, virtual educations, virtual offices, animations, and the like. Through avatars, modern users create personal relationships, do online chatting, play online games, exchange information, or learn again how to see, how to read and speak, and how to behave towards other persons.

Avatar is an imaginary body which represents a user in a graphic-based virtual world. However, most of conventional avatars have been merely two-dimensional pictures. Avatars appearing in MUD (multi-user dungeon) game or online chatting have remained just on the beginner level. In order to remedy such shortcomings, three-dimensional avatars having cubic effect and reality are developed. These avatars liaise between the real world and a virtual space, and also exist in the midpoint between a pseudonym and a real name.

Respective objects of conventional virtual worlds are designed and created depending on each virtual world supported by each server. Namely, a virtual object or avatar that exists in a specific virtual world cannot be used in any other virtual world. Accordingly, a system and method for operating virtual objects and avatars available for various virtual worlds are required in the art.

### DETAILED DESCRIPTION OF THE INVENTION

### Technical Problems

In order to solve the above-discussed problem, one object of the present invention is to provide a virtual world operating system and method for defining common characteristics of virtual object characters and avatars in a virtual world.

Additionally, another object of the present invention is to provide a virtual world operating system and method for supporting functions associated with extensive operation of objects and avatars in a virtual world by utilizing a semantic function and enhanced XML schema spec of MPEG-V.

### Technical Solutions

A virtual world operating system of the present invention comprises a service server and a network. The network is configured to support data transmission and reception of the service server. The service server is configured to define, based on MPEG-V, a common characteristics type of VirtualObjectType and AvatarType in the virtual world.

In the virtual world operating system of this invention, the service server may be further configured to define an identifier of a virtual world object in MPEG-V XML schema so as to distinguish respective objects existing in the at least one virtual world, and an identifier of an avatar in the MPEG-V XML schema so as to distinguish one or more avatars operated in the at least one virtual world.

In the virtual world operating system of this invention, the service server may be further configured to define a specific ID or a specific URI to the object or the avatar so as to define the identifier.

In the virtual world operating system of this invention, the service server may be further configured to create contents which contain, at least in part, data of object or avatar having the identifier.

Additionally, the present invention provides a virtual world operating method based on MPEG-V. The method comprises step of defining common characteristics of virtual object types of virtual objects constituting at least one virtual world, and step of defining common characteristics of avatar types of one or more avatars operated in the at least one virtual world.

The virtual world operating method of this invention claim 5 may further comprise step of defining identifiers for identifying the virtual objects and the avatars.

### Advantageous Effects

According to a virtual world operating system and method of the present invention, it is possible to effectively and uniquely distinguish virtual world objects by using common characteristics of enhanced virtual world objects.

Additionally, the present invention may support, based on uniquely distinguishable virtual objects, the construction of an integrated virtual world which originates from several virtual worlds.

Further, the present invention may easily and conveniently support Internet services familiar to users on the basis of the construction of the above-mentioned integrated virtual world.

The present invention may interconnect public virtual worlds, business virtual worlds, and private virtual worlds in the future Internet, 3D Web, so that users can utilize public virtual worlds as gateways to other virtual worlds by using them like existing Internet portals.

As a result, using virtual world technologies discussed herein, the present invention may contribute to the invigoration of various fields by amplifying relationship among the whole ranges of society, culture, industry, and education.

### DESCRIPTION OF THE DRAWING

FIG. 1 is a schematic view illustrating a virtual world constructing system in accordance with an embodiment of the present invention.

FIG. 2 is an example view illustrating one aspect of a virtual world in accordance with an embodiment of the present invention.

### MODE FOR CARRYING OUT THE INVENTION

Hereinafter, a preferred embodiment of the present invention will be described in detail with reference to the accompanying drawings. The following descriptions are provided to assist in a comprehensive understanding of the embodiments. Well known techniques, elements, structures, and processes will be omitted to avoid obscuring the subject matter of the present invention.

Particular terms may be defined to describe the invention in the best manner. Accordingly, the meaning of specific terms or words used in the specification and the claims should not be limited to the literal or commonly employed sense, but should be construed in accordance with the spirit of the invention as described herein. The description of the various embodiments is to be construed as exemplary only and does not describe every possible instance of the invention. Therefore, it should be understood that various changes may be made and equivalents may be substituted for various elements of the invention.

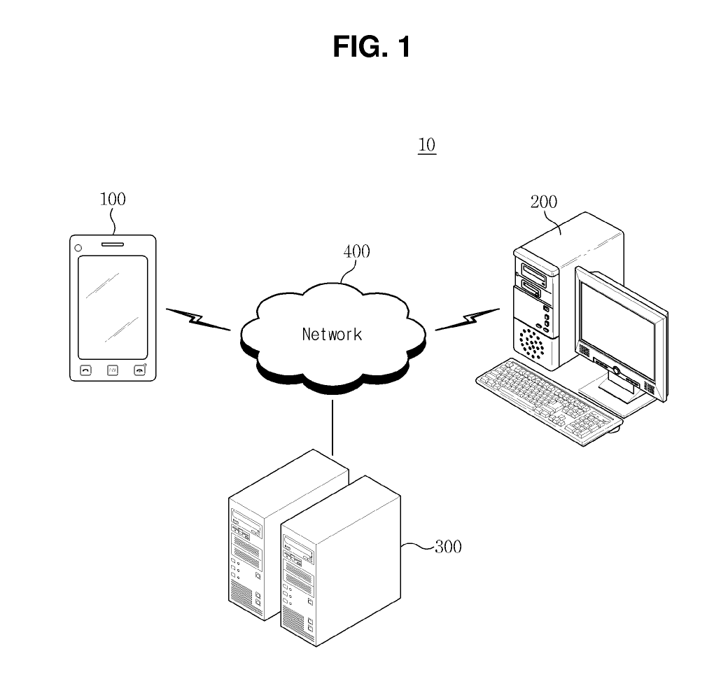

FIG. 1 is a schematic view illustrating a virtual world constructing system having elements necessary for the construction of a virtual world in accordance with an embodiment of the present invention.

Referring to FIG. 1, the virtual world constructing system 10 may include one or more user terminals 100 and 200, at least one service server 300 for providing a virtual world, and a network 400 for connecting the user terminal 100 or 200 and the service server 300.

The virtual world constructing system 10 having the above elements allows the service server 300 to store widespread data for constructing a virtual world in database. Additionally, the virtual world constructing system 10 may provide a program, i.e., an engine, capable of constructing a virtual space, i.e., a virtual world, based on data stored in the database. In this state, the user terminal 100 or 200 may access a virtual world provided by the service server 300 and operate avatars provided by the service server 300. Also, by operating avatars, the user terminal 100 or 200 may retrieve a variety of information from a virtual world provided by the service server 300. Such information provided by the service server 300 includes data about a virtual world as well as avatar information. The user terminal 100 or 200 receives information about a virtual world and about avatars from the service server 300 and then displays the received information on a display unit. This allows a user to easily understand current circumstances of a virtual world where avatars are placed, and thereby to send specific instructions. Particularly, by performing the definition of common characteristics for avatars which are controlled and operated in virtual world objects or in a virtual world by the user terminal 100 or 200, the virtual world constructing system 10 may allow virtual objects or avatars to be available in a virtual world constructed by any other service server 300. Objects and avatars constituting a virtual world may be particular contents which contain, at least in part, data forming the objects and avatars. Therefore, the virtual world constructing system 10 may perform the definition of common characteristics type for various contents provided by the service server 300. Now, detailed descriptions for each element will be made.

The user terminal 100 or 200 is configured to access a virtual world constructed by the service server 300 and to receive various data provided by the service server 300 through the network 400. The user terminal 100 or 200 is further configured to output the received data and to transmit data indicated by a user to the service server 300 through the network 400. For the above, the user terminal 100 or 200 may include a communication module for establishing a communication channel with the network 400, a central processing unit for processing the received data, audio and video output units for outputting the processed data, and an input unit for receiving input instructions from a user. Additionally, the user terminal 100 or 200 may further include a camera, sensors, and the like in order to acquire various kinds of information and to transmit such information to the service server 300 according to user's manipulations. The user terminal 100 or 200 may have some elements required for a wireless or wired access to the network 400. When a user inputs any data for avatar control and operation, the user terminal 100 or 200 may encode such data to meet the transmission standard and then transmit the encoded data to the service server 300 through the network 400. These respective data may be recognized as unique resources in the virtual world constructing system 10. Since avatars provided by the virtual world constructing system 10 are uniquely defined, information outputted in a virtual world by the avatars may be also uniquely defined according to data definition scheme, e.g., MPEG-V standards.

The network 400 connects the user terminal 100 or 200 and the service server 300. Namely, the network 400 not only offers, to the user terminal 100 or 200, information about various virtual worlds and about avatars provided by the service server 300, but also delivers, to the service server 300, information created for avatar operation and access information for access of the user terminal 100 or 200 to the service server 300. The network 400 may include a variety of physical configurations according to communication standards or forms of the user terminals 100 and 200, and depending on available communication mode, performs data relay between the user terminal 100 or 200 and the service server 300. Therefore, the network 400 is not limited to specific communication equipment or specific base station and should be considered as an integrated entity of various communication devices capable of data transmission between the user terminal 100 or 200 and the service server 300.

The service server 300 provides a virtual world and information about avatars operated in the virtual world. Particularly, the service server 300 uniquely defines various objects constructing a virtual world and a number of avatars operated in the virtual world, thus supporting a common operation of respective avatars and objects. Additionally, the service server 300 defines and operates common characteristics for objects and avatars of a virtual world, thus supporting a comprehensive and effective management of various objects. For the above, the service server 300 may define types of respective objects according to MPEG-V standards such that each object can have unique characteristics. Particularly, the service server 300 may store objects and avatars with unique identifiers. This will be described below in detail. The service server 300 may include a communication module configured to communicate with the network 400, a database configured to store various data for constructing a virtual world, a database configured to store avatar data, and a control unit configured to construct a virtual world on the basis of the data stored in each database and to operate avatars by using operation information received from the user terminal 100 or 200.

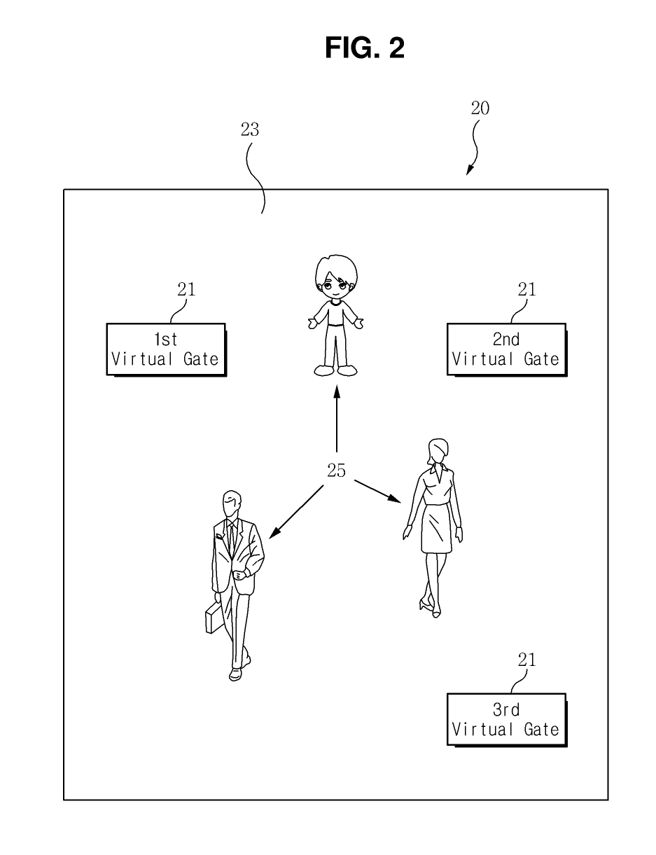

As discussed above, by performing the definition of common characteristics for respective virtual worlds constructed by various service servers 300 and for avatars defined in each virtual world, the virtual world constructing system 10 not only supports links and compatibility of objects between virtual worlds, but also allows independent recognition of each object. Therefore, the user terminal 100 or 200 which operates avatars can, by using its own avatars, access, move between, or leave the virtual worlds provided by various service servers 300 and perform sharing or delivery of information between avatars existing in the virtual worlds. Now, the construction of such a virtual world will be described in detail with reference to FIG. 2.

FIG. 2 is an example view illustrating one aspect of a virtual world that operates based on the virtual world constructing system 10 in accordance with an embodiment of the present invention.

Referring to FIG. 2, the virtual world 20 constructed by the virtual world constructing system 10 may include one or more virtual gates 21 for allowing a movement to another virtual world constructed by various service servers 300, a virtual space 23 for arranging the virtual gates 21 therein, and one or more avatars 25 disposed in the virtual space 23. Although the virtual world 20 constructed by the virtual world constructing system 10 is expressed herein as including simply the virtual gates 21, the virtual space 23 and the avatars 25, this is exemplary only and not to be considered as a limitation of the present invention. Namely, the virtual world 20 constructed by the virtual world constructing system 10 may further include a variety of virtual objects such as backgrounds, articles, sounds, music, etc. which may be additionally disposed in the virtual space 23.

In this virtual world 20, the virtual world 23 may be realized in the user terminal 100 or 200, and the virtual gates 21 may be outputted according to a given mode or predetermined information and disposed in the virtual space 23. When the user terminal 100 or 200 that registers in advance specific avatar information accesses the service server 300 for providing the virtual world 20 and creates data for avatar operation, the service server 300 may operate specific one of the avatars 25 in the virtual world 20 according to such data. Particularly, the service server 300 not only defines common characteristics of respective objects, i.e., the virtual gates 21 and the avatars 25, constituting the virtual world 20 under the definition of common characteristic type in MPEG-V, but also uniquely defines each object or avatar. This allows the virtual gates 21 and the avatars 25 to be operated in another virtual world constructed by any other service server.

The virtual space 23 may be constructed using virtual space coordinates defined by the service server 300. Also, this virtual space 23 may be defined with a size capable of containing various data offered by the service server 300. Various types of virtual objects may be disposed in the virtual space 23. Each virtual object may remain stationary, take an action like a movement within a given range according to the definition of corresponding data, or output a given sound. The virtual space 23 is stored in the form of data in the database, transmitted to the user terminal 100 or 200, and outputted through a display unit and an audio processing unit of the user terminal 100 or 200. Therefore, a user can recognize such data as the virtual space.

As discussed above, the virtual gate 21 is uniquely defined by the service server 300 and configured to perform a role of gate for entry into another virtual world. The virtual gate 21 shows that the avatars 25 defined uniquely can be operated with having common characteristics in any other virtual world. The virtual gate 21 may be activated when an event for moving to other virtual world through the virtual gate 21 occurs. If a specific virtual gate 21 is activated in response to the approach of a selected avatar 25, data of this avatar 25 may be transferred to a new virtual world provided by a particular service server indicated by the specific virtual gate 21. Then the service server receiving data of the avatar 25 may reconfigure the avatar 25 in the new virtual world and deliver information about corresponding situations and environments to the user terminal 100 or 200 associated with the avatar 25. Therefore, the avatar 25 may be operated in the new virtual world. Here, data which constitutes the virtual world may be reconfigured with reference to only parts having common characteristics and defined uniquely. This not only can reduce time required for reconfiguration of avatars, but also can quickly process entry of avatars 25 into a virtual world. Although three virtual gates 21 are illustrated, this is exemplary only and not to be considered as a limitation of the present invention.

Meanwhile, the avatar 25 is based on the definition of common characteristics type according to MPEG-V standards, and may include various and unique information defined by the user terminal 100 or 200 or depending on features of the service server 300 that supports the creation of the avatar 25. Such information may be modified by a user of the user terminal 100 or 200 or altered through interrelation with various virtual worlds. Namely, the avatar 25 may have different appearances according to definitions by a user or the service server 300. For example, user's own avatar 25 may have information about name or appearance such that a user can easily perceive the location or the like of his or her avatar 25 in the small virtual space 23. Such information may have an effect for distinguishing the user's avatar from the others in the user terminal 100 or 200. Additionally, the avatar 25 may be applied on the basis of the definition of common characteristics type, depending on features of the virtual world 20 where the avatar 25 is located. Here, the avatar 25 may have identifier, e.g., URI (Uniform Resource Identifier) or ID information, so as to be uniquely applied.

As discussed above, the virtual world constructing system 10 in an embodiment of this invention supports the definition and operation for MPEG-V Part 4 (Virtual World Object Characteristics) XML schema for the definition of data, i.e., various objects, operated in the virtual world 20, thereby performing the definition of common characteristics for such virtual objects.

Now, the schema definition for the operation of virtual objects and avatars provided by the virtual world constructing system 10 of this invention will be described using MPEG-V XML schema.

In conventional MPEG-V XML schema, VWOSound (Virtual World Object Sound) and VWOScent (Virtual World Object Scent) elements are defined as 0 or 1, while having different values in semantic because of the existence of links more than one. Meanwhile, in CommonCharacteristicsType, two element types are defined. One type refers to static list information for using the structure of virtual world object behavior, and the other type refers to behavior information of other actual elements. In this CommonCharacteristicsType, the abstract type has a rough definition of virtual object. However, this fails to explain concretely AvatarType and VirtualObjectType. Accordingly, the virtual world constructing system 10 of this invention provides a method for uniquely defining objects of a virtual world in a number of virtual environments so as to realize a unified virtual object operation in various virtual worlds.

Specifically, the virtual world constructing system 10 of this invention may allocate identifiers for the identification of virtual objects and avatars, and for this, may define Name, Family, and a further combination of UserID in CommonCharacteristicsType defined in MPEG-V Part 4, as follows.

-Identification-

| | |
|---|---|
| <xsd:complexType | name=“CommonCharacteristicsType” |

```
abstract=“true”>
  <xsd:sequence>
  <xsd:element name=“Identification” type=“IdentificationType”/>
```

| | | |
|---|---|---|
| <xsd:element | name=“VWOSound” | type=“VWOSoundType” |

minOccurs=“0”/>

| | | |
|---|---|---|
| <xsd:element | name=“VWOScent” | type=“VWOScentType” |

minOccurs=“0”/>

| | | |
|---|---|---|
| <xsd:element | name=“VWOControl” | type=“VWOControlType” |

minOccurs=“0”/>

| | | |
|---|---|---|
| <xsd:element | name=“VWOEvent” | type=“VWOEventType” |

minOccurs=“0”/>

| | |
|---|---|
| <xsd:element | name=“VWOBehaviorModel” |

type=“VWOBehaviorModelType” minOccurs=“0”/>

| | |
|---|---|
| <xsd:element | name=“VWOHapticProperties” |

```
type=“VWOHapticPropertyType” minOccurs=“0”/>
  </xsd:sequence>
  </xsd:complexType>
  <xsd:complexType name=“IdentificationType”>
  <xsd:annotation>
  <xsd:documentation>Comment describing your root
element</xsd:documentation>
  </xsd:annotation>
  <xsd:sequence>
  <xsd:element name=“UserID” type=“xsd:anyURl” minOccurs=“0”/>
```

| | | |
|---|---|---|
| <xsd:element | name=“Ownership” | type=“mpeg7:AgentType” |

minOccurs=“0”/>
<xsd:element name=“Rights” type=“r:License” minOccurs=“0”
maxOccurs=“unbounded”/>

| | | |
|---|---|---|
| <xsd:element | name=“Credits” | type=“mpeg7:AgentType” |

```
minOccurs=“0” maxOccurs=“unbounded”/>
  <!-- Extend the agentType to have the number in chronological
order.-->
  </xsd:sequence>
  <xsd:attribute name=“VOID” type=“xsd:anyURl”/>
  <xsd:attribute name=“Name” type=“xsd:string” use=“optional”/>
  <xsd:attribute name=“Family” type=“xsd:string” use=“optional”/>
  </xsd:complexType>
```

As discussed above, the virtual world constructing system 10 of this invention, and objects and avatars operated by the system, may be defined to have unique information in attribute by using specific URI as VOID (VirtualObject Identification).

Additionally, the virtual world constructing system 10 of this invention may uniquely define VWOSound and VWOScent elements that are defined as 0 or 1 in XML schema and have different values in semantic because of the existence of links more than one. Also, VWOSound and VWOScent defined in CommonCharacteristicsType are referred to and executed in VWOBehaviorModel. And also, Sound object and Scent object have guarantee of unique feature by ID. Therefore, at least one of Sound object and Scent object may be referred to from a behavior model and support matters occurring in a virtual world. Further, it is possible to have one unique ID per element through URI. For that reason, one or more resources may be clearly defined, as follows.

```
  -VWOSound, VWOScent-
  <xsd:complexType name=“VWOSoundType”>
  <xsd:sequence>
  <xsd:element name=“SoundResourcesURL” type=“xsd:anyURl” />
  </xsd:sequence>
  <xsd:attribute name=“SoundID” type=“xsd:ID”/>
  <xsd:attribute name=“Intensity” type=“xsd:decimal” use=“optional”/>
```

| | | |
|---|---|---|
| <xsd:attribute | name=“Duration” | type=“xsd:unsignedInt” |

```
use=“optional”/>
  <xsd:attribute name=“Loop” type=“xsd:unsignedInt” use=“optional”/>
  <xsd:attribute name=“Name” type=“xsd:string” use=“optional”/>
  </xsd:complexType>
  <xsd:complexType name=“VWOScentType”>
  <xsd:sequence>
  <xsd:element name=“ScentResourcesURL” type=“xsd:anyURl”/>
  </xsd:sequence>
  <xsd:attribute name=“ScentID” type=“xsd:ID”/>
  <xsd:attribute name=“Intensity” type=“xsd:decimal” use=“optional”/>
```

| | | |
|---|---|---|
| <xsd:attribute | name=“Duration” | type=“xsd:unsignedInt” |

```
use=“optional”/>
  <xsd:attribute name=“Loop” type=“xsd:unsignedInt” use=“optional”/>
  <xsd:attribute name=“Name” type=“xsd:string” use=“optional”/>
  </xsd:complexType>
```

Namely, as discussed above, it is possible to uniquely define Sound object and Scent object by means of URI of each resource. Also, it is possible to distinguishably define various resources by allocating ID to each object.

As proposed herein, the virtual world constructing system 10 of this invention defines new schema of CommonCharacteristicsType, as follows.

-CommonCharacteristicsType-

| | |
|---|---|
| <xsd:complexType | name=“CommonCharacteristicsType” |

```
abstract=“true”>
  <xsd:sequence>
  <xsd:element name=“Identification” type=“IdentificationType”/>
  <xsd:element name=“VWOFoundation”/>
  <xsd:complexType>
  <xsd:sequence>
```

| | | |
|---|---|---|
| <xsd:element | name=“VWOSoundList” | type=“VWOSoundListType” |

minOccurs=“0”/>

| | | |
|---|---|---|
| <xsd:element | name=“VWOScentList” | type=“VWOScentListType” |

minOccurs=“0”/>

| | | |
|---|---|---|
| <xsd:element | name“=VWOAnimationList” | type=“VWOAnimationList |

Type” minOccurs=“0”/>

| | | |
|---|---|---|
| <xsd:element | name=“VWOEventList” | type=“VWOEventListType” |

```
minOccurs=“0”/>
  </xsd:sequence>
  </xsd:complexType>
  </xsd:element>
```

| | |
|---|---|
| <xsd:element | name=“VWOBehaviorModelList” |

type=“VWOBehaviorModelListType” minOccurs=“0”/>

| | |
|---|---|
| <xsd:element | name=“VWOHapticPropertyList” |

```
type=“VWOHapticPropertyListType” minOccurs=“0”/>
  </xsd:sequence>
  </xsd:complexType>
  <xsd:complexType name=“VWOSoundListType”>
  <xsd:sequence>
```

| | | |
|---|---|---|
| <xsd:element | name=“VWOSound” | type=“VWOSoundType” |

```
maxOccurs=“unbounded”/>
  </xsd:sequence>
  </xsd:complexType>
  <xsd:complexType name=“VWOScentListType”>
  <xsd:sequence>
```

| | | |
|---|---|---|
| <xsd:element | name=“VWOScent” | type=“VWOScentType” |

```
maxOccurs=“unbounded”/>
  </xsd:sequence>
  </xsd:complexType>
  <xsd:complexType name=“VWOAnimationListType”>
  <xsd:sequence>
```

| | | |
|---|---|---|
| <xsd:element | name=“VWOAnimation” | type=“VWOAnimationType” |

```
maxOccurs=“unbounded”/>
  </xsd:sequence>
  </xsd:complexType>
  <xsd:complexType name=“VWOEventListType”>
  <xsd:sequence>
```

| | | |
|---|---|---|
| <xsd:element | name=“VWOEvent” | type=“VWOEventType” |

```
maxOccurs=“unbounded”/>
  </xsd:sequence>
  </xsd:complexType>
  <xsd:complexType name=“VWOBehaviorModelListType”>
  <xsd:sequence>
```

| | |
|---|---|
| <xsd:element | name=“VWOBehaviorModel” |

```
type=“VWOBehaviorModelType” maxOccurs=“unbounded”/>
  </xsd:sequence>
  </xsd:complexType>
  <xsd:complexType name=“VWOHapticPropertyListType”>
  <xsd:sequence>
```

| | |
|---|---|
| <xsd:element | name=“VWOHapticProperty” |

```
type=“VWOHapticPropertyType” maxOccurs=“unbounded”/>
  </xsd:sequence>
  </xsd:complexType>
  [New Schema of VWOBehaviorModelType]
  <xsd:complexType name=“VWOBehaviorModelType”>
  <xsd:sequence>
```

| | | |
|---|---|---|
| <xsd:element | name=“BehaviorInput” | type=“BehaviorInputType” |

minOccurs=“0”/>

| | | |
|---|---|---|
| <xsd:element | name=“BehaviorOutput” | type=“BehaviorOutputType” |

```
minOccurs=“0”/>
  </xsd:sequence>
  </xsd:complexType>
  <xsd:complexType name=“BehaviorInputType”>
  <xsd:attribute name=“EventID” type=“xsd:IDREF” use=“optional”/>
  </xsd:complexType>
  <xsd:complexType name=“BehaviorOutputType”>
  <xsd:attribute name=“SoundID” type=“xsd: IDREF ” use=“optional”/>
  <xsd:attribute name=“ScentID” type=“xsd: IDREF ” use=“optional”/>
```

| | | |
|---|---|---|
| <xsd:attribute | name=“AnimationID” | type=“xsd: IDREF |

```
”use=“optional”/>
  </xsd:complexType>
  [New Schema of AvatarType]
  <xsd:complexType name=“AvatarType”>
  <xsd:complexContent>
  <xsd:extension base=“CommonCharacteristicsType”>
  <xsd:sequence>
```

| | |
|---|---|
| <xsd:element | name=“AvatarAppereance” |

| | |
|---|---|
| type=“AvatarAppearanceType” | minOccurs=“0” |

maxOccurs=“unbounded”/>
<xsd:element name=“AvatarAnimation” type=“AvatarAnimationType”
minOccurs=“0” maxOccurs=“unbounded”/>

| | |
|---|---|
| <xsd:element | name=“AvatarCommunicationSkills” |

| | |
|---|---|
| type=“AvatarCommunicationSkillsType” | minOccurs=“0” |

maxOccurs=“unbounded”/>

| | |
|---|---|
| <xsd:element | name=“AvatarPersonality” |

| | |
|---|---|
| type=“AvatarPersonalityType” | minOccurs=“0” |

maxOccurs=“unbounded”/>

| | |
|---|---|
| <xsd:element | name=“AvatarControlFeatures” |

| | |
|---|---|
| type=“AvatarControlFeaturesType” | minOccurs=“0” |

```
maxOccurs=“unbounded”/>
  </xsd:sequence>
  <xsd:attribute name=“Gender” type=“xsd:string” use=“optional”/>
  </xsd:extension>
  </xsd:complexContent>
  </xsd:complexType>
  [New Schema of VirtualObjectType]
  <xsd:complexType name=“VirtualObjectType”>
  <xsd:complexContent>
  <xsd:extension base=“CommonCharacteristicsType”>
  <xsd:sequence>
```

| | | |
|---|---|---|
| <xsd:element | name=“VOAppearance” | type=“VOAppearanceType” |

minOccurs=“0” maxOccurs=“unbounded”/>

| | | |
|---|---|---|
| <xsd:element | name=“VOAnimation” | type=“VOAnimationType” |

```
minOccurs=“0” maxOccurs=“unbounded”/>
  <xsd:element name=“VOCC” type=“CommonCharacteristicsType”
minOccurs=“0”/>
  </xsd:sequence>
  </xsd:extension>
  </xsd:complexContent>
  </xsd:complexType>
```

As fully discussed heretofore, the virtual world constructing system 10 and the virtual object operation method supported by the system in this invention may define VirtualObjectType and AvatarType as common characteristics type in VWOBehaviorModelType where Sound, Scent, Animation, etc. are used, based on reference ID information. Therefore, while respective virtual objects and avatars are managed by means of common characteristics, each of virtual objects and avatars is uniquely defined. Accordingly, the system and method for operating objects and avatars in a virtual world may allow the construction of a new and integrated virtual world by using virtual objects and avatars having common characteristics but defined uniquely, and thus support a linked operation of various avatars on the basis of such a virtual world.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

What is claimed is:

1. A virtual world operating system comprising:
at least one service server configured to store data for constructing at least one virtual world, and to construct the virtual world based on the data; and
a network configured to support a communication path for access to the service server,
wherein the service server is further configured to define, based on MPEG-V, a common characteristics type of VirtualObjectType and AvatarType in the virtual world.

2. The virtual world operating system of claim 1, wherein the service server is further configured to define:
an identifier of a virtual world object in MPEG-V XML schema so as to distinguish respective objects existing in the at least one virtual world; and
an identifier of an avatar in the MPEG-V XML schema so as to distinguish one or more avatars operated in the at least one virtual world.

3. The virtual world operating system of claim 2, wherein the service server is further configured to define a specific ID or a specific URI to the object or the avatar so as to define the identifier.

4. The virtual world operating system of claim 1, wherein the service server is further configured to create contents which contain, at least in part, data of object or avatar having the identifier.

5. A virtual world operating method based on MPEG-V, the method comprising steps of:
defining common characteristics of virtual object types of virtual objects constituting at least one virtual world; and
defining common characteristics of avatar types of one or more avatars operated in the at least one virtual world.

6. The virtual world operating method of claim 5, further comprising step of:
defining identifiers for identifying the virtual objects and the avatars.
